(19) United States
(12) Patent Application Publication
(10) Pub. No.: US 2005/0156905 A1
(43) Pub. Date: Jul. 21, 2005

(54) Electrode pattern for touch panels

(75) Inventors: Chun-Hao Wang, Hemei Township (TW); Di-Shing Tsai, Cingshuei Township (TW); Chen-Ming Wu, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/017,837

(22) Filed: Dec. 22, 2004

(30) Foreign Application Priority Data
Dec. 26, 2003 (TW) 92222695

(51) Int. Cl. G09G 5/00

(52) U.S. Cl. 345/173

(57) ABSTRACT

An electrode pattern for touch panels is continuous with a border. Each side of the border has two ends formed respectively a straight line and a middle portion formed a curve directing inwards towards a touch area. The touch area surrounded by the electrode pattern has a uniform impedance. When an external voltage is applied to the electrode pattern, a continuous potential difference altering linearly is formed such that the touch area can output an electric signal to be precisely detected by a computer.

### FIELD OF THE INVENTION

The present invention relates to an electrode pattern to provide linear response for touch panels and particularly to an electrode pattern for five-wire resistance type touch panels.

### BACKGROUND OF THE INVENTION

Advances of technology have made input devices of information, communication and electronic products more diversified. The touch panel is a novel and more humanized input device, thus has gained growing acceptance. The touch panel includes a glass panel consisting of a conductive glass and a conductive film. It is an input device to display required images by touch through a wire configuration and a control IC on a circuit board.

As the touch panel has a humanized input interface, an item may be directly selected through a finger or a stylus according to the function shown on the picture without any instruction or learning. Its application scope is very large. The main applications include: (1) portable communication, consumer electronic, and information products: such as personal digital assistant (PDA), Palm-Sized PC, electronic dictionary, hand-written input devices, information appliances, new generation of broadband mobile phones (3G and GPRS handsets), and stock information display devices; (2) financial/business applications: such as ATM/ticket selling system, sales system, distance teleconference, and telephone remote terminal systems; (3) medical and healthcare applications: such as register system, surgical table monitoring, and medical tracking; (4) industrial applications: such as plant automation control system, remote/central monitoring system, workstation operating system, and management information system (MIS); (5) public information applications: such as airport guiding system, exhibit instruction system, and land information inquiry system; and (6) instruction/game applications: such as game stations in entertainment arcades, children computer assist instructions, and the like.

At present, the biggest market for the touch panel is in industrial applications, followed by guiding applications, sales checking counters, and medical and game applications. As the PDA, IA and handset will gradually adopt the touch panel in the future, the applications of the touch panel in the portable communication and consumer electronic products will continuously grow and become very important.

The touch panel, according to the operation mode, can be classified as resistance type, capacitance type, sound wave type, optical type, load variation type, and the like. The resistance type is the mostly used one. Depending on the design of vendors, it can be divided into four-wire, five-wire, and six-wire structure.

The resistance type adopts a technical principle that uses an ITO glass and an ITO film that have a dot spacer on an upper and lower transparent electrodes lay in the X and Y coordinates. When the electrodes are subject to a pressure from a finger, pen or other medium, the upper and lower electrodes are set ON indirectly to generate a potential difference. The cross spot of the upper and lower circuit forms a switch. Hence compression generates ON and OFF functions. The ON/OFF signals are transferred by a flat cable to a controller for processing, and the coordinate location of the compression may be calculated and derived.

The five-wire resistance type touch panel uses a low resistance silver paste and a high impedance conductive substrate. The conductive silver paste is printed in a pattern to form a electrode pattern layer on the conductive substrate. Due to the characteristics of the conductive silver paste and the requirement for a uniform electric field in the touch area, the electrode pattern of a product generally is designed in a separated and non-continuous pattern.

For instance, if a conventional electrode pattern 10 is designed as a quadrilateral pattern with a continuous border of four sides (referring to FIG. 1), when an external constant voltage is applied on four comers of the film electrode pattern 10, the voltage is transferred to a conductive substrate 13 through the film electrode pattern 10. With the electrode pattern 10 designed in rectangular, the impedance of the film electrode pattern 10 and the conductive substrate 13 forms a voltage drop which increases with increasing of the distance. When the detection position is close to the four corners, due to influence of the circuits on two neighboring sides, the impedance relative to the circuit at the corners is smaller than in the middle portion. Hence the voltage line 12 measured on a detection dot line 11 at the equidistance in parallel with the electrode pattern 10 is formed in a curve.

Some conventional design has a continuous electrode pattern 20 formed in a concave curve directing inwards (referring to FIG. 2). The impedance of the same film electrode pattern 20 and the conductive substrate 23 increases with increasing of the distance. When an external voltage is applied, if the touch position detection dot line 21 is closer to the four corners of the circuit, due to influence of the circuits on two neighboring sides, the impedance relative to the circuit at the corners is smaller than in the middle portion. Hence the voltage line 22 measured on a detection dot line 21 at the equidistance in parallel with the electrode pattern mostly can be corrected. But the corners are over-corrected and result in a lower impedance and a deviation of the voltage line 22.

### SUMMARY OF THE INVENTION

Therefore the primary object of the present invention is to solve the disadvantages of the conventional electrode pattern design such as the difficult fabrication process caused by separation and non-continuity, lower production yield, and the undesirable electrode pattern with a continuous border of four sides mentioned above. The invention provides a liner circuit for touch panels. The touch panel according to the invention includes a lower substrate, a electrode pattern layer, a dot spacer, a first insulation layer, a conductive wire layer, a second insulation layer, and an upper substrate. The feature of the invention is that the continuous electrode pattern layer is a rectangular circuit with continuous four sides. The electrode pattern on each side has two ends formed respectively a straight line rather than a curve directing inwards so that the phenomenon of the voltage line deviation caused by over-correction and the too low impedance is improved. The middle portion of each side of the electrode pattern forms a curve directing inwards towards a touch area. Thus the curved voltage line measured at the equidistance in parallel with the electrode pattern occurred to the conventional straight electrode pattern also is improved.

Therefore, when a voltage is applied to the film electrode pattern, the touch area surrounded by the electrode pattern has a uniform impedance and forms a potential difference which is continuous and alters linearly. As a result, the electric signal output from the touch area can be accurately detected by a computer. When users write, draw graphics or select functions on the touch panel, the computer can precisely determine the selected location. And either the middle or the edge portion of the touch area can provide a precise touch positioning.

The foregoing, as well as additional objects, features, and advantages of the invention will be more readily apparent from the following detailed description, which proceeds with reference to the accompanying drawings.

### BRIEF DESCRIPTION OF THE DRAWINGS

FIG. 1 is a schematic view of a conventional electrode pattern-voltage line.

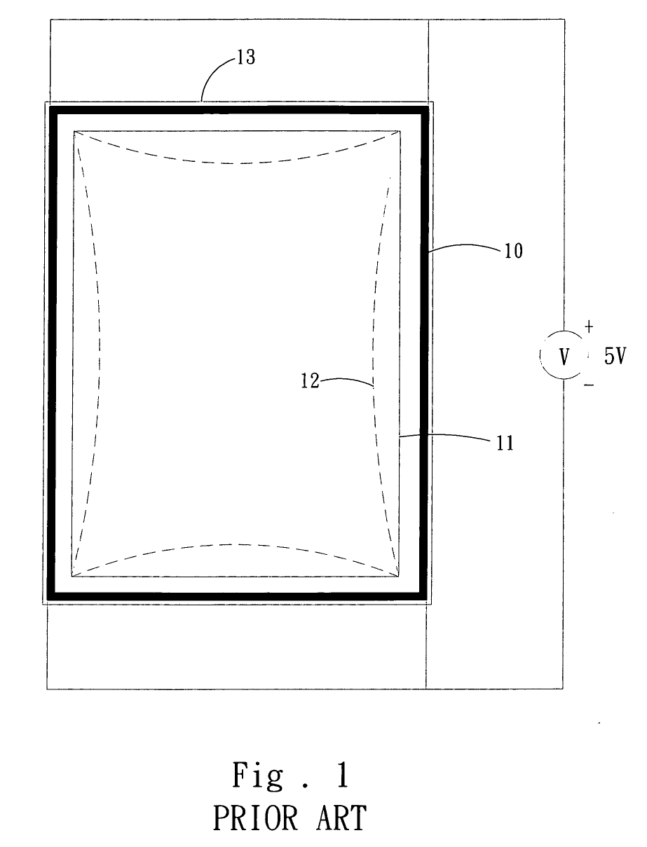

FIG. 2 is a schematic view of another conventional electrode pattern-voltage line.

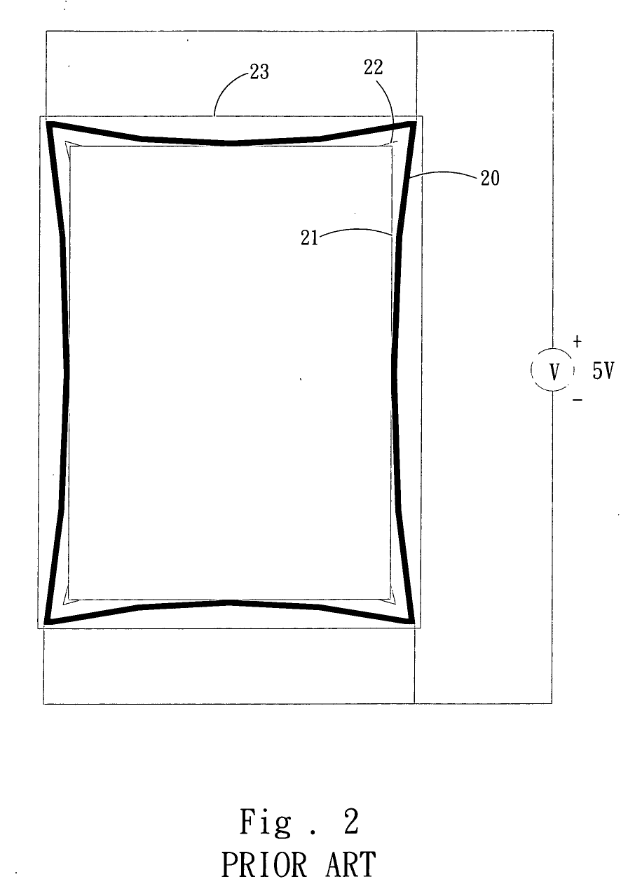

FIG. 3 is an exploded view of a touch panel according to the invention.

FIG. 4 is a schematic view of a electrode pattern-voltage line according to the invention.

### DETAILED DESCRIPTION OF THE PREFERRED EMBODIMENTS

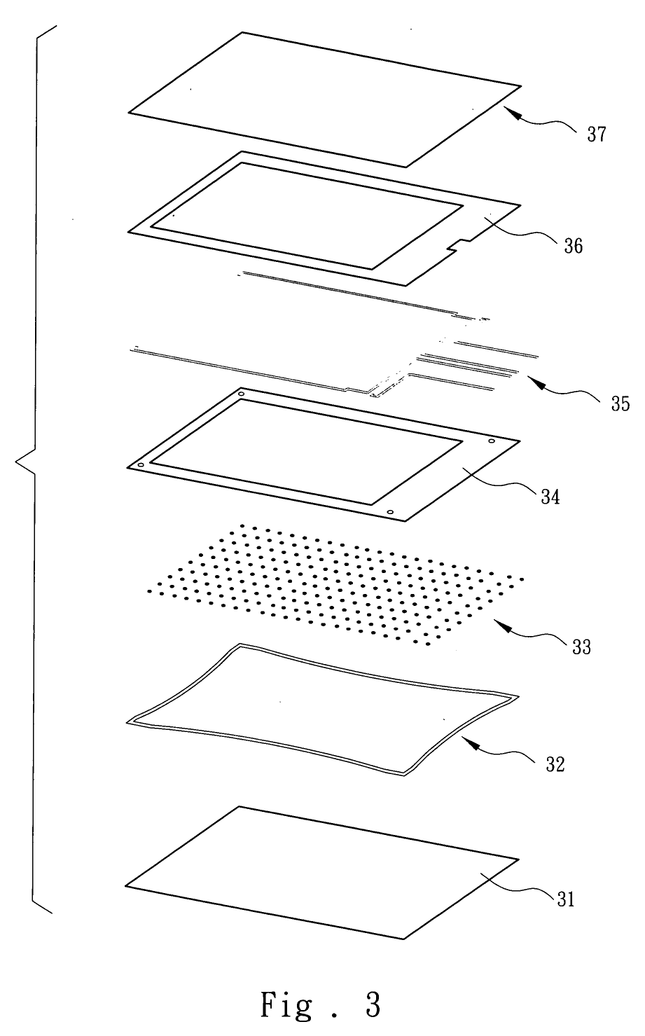

Refer to FIG. 3 for an exploded view of a touch panel according to the invention. The invention aims to provide a electrode pattern for a touch panel. The touch panel includes, from bottom to top in this order, a lower substrate 31, a dot spacer 33, a electrode pattern layer 32, a first insulation layer 34, a conductive wire layer 35, a second insulation layer 36, and an upper substrate 37.

The lower substrate 31 may be formed by uniformly depositing ITO (Indium Tin Oxide) on a glass to form a conductive film of an uniform sheet resistance. The dot spacer 33 may be formed by printing on the lower substrate 31.

The electrode pattern layer 32 may be formed by depositing ITO (Indium Tin Oxide) on the peripheral border of the glass with a circuit pattern formed by etching, then fabricate the lower substrate 31. Another approach is to deposit chrome (Cr) on the peripheral border of the lower substrate 31, then form the circuit pattern by etching. Yet another approach is to deposit after a mask has been deployed, then remove the mask to fabricate the electrode pattern. Hence the electrode pattern layer 32 may be formed on the lower substrate 31 by depositing or etching.

The conductive wire layer 35 may be formed by printing on the area of lower substrate not coated by ITO film, and connecting to four comers of the electrode pattern layer 32. Alternatively, the conductive wire area 35 may also be formed by connecting to the four corners of the electrode pattern layer 32 through a flat cable. The first insulation layer 34 and the second insulation layer 36 may be formed on the lower substrate 31 by printing. The upper substrate 37 may be formed by depositing ITO on PolyEthyleneTerepthalate (PET), namely the upper substrate 37 is a transparent conductive film with an uniform sheet resistance. The aforesaid elements are stacked in the order depicted above to form a five-wire resistance touch panel.

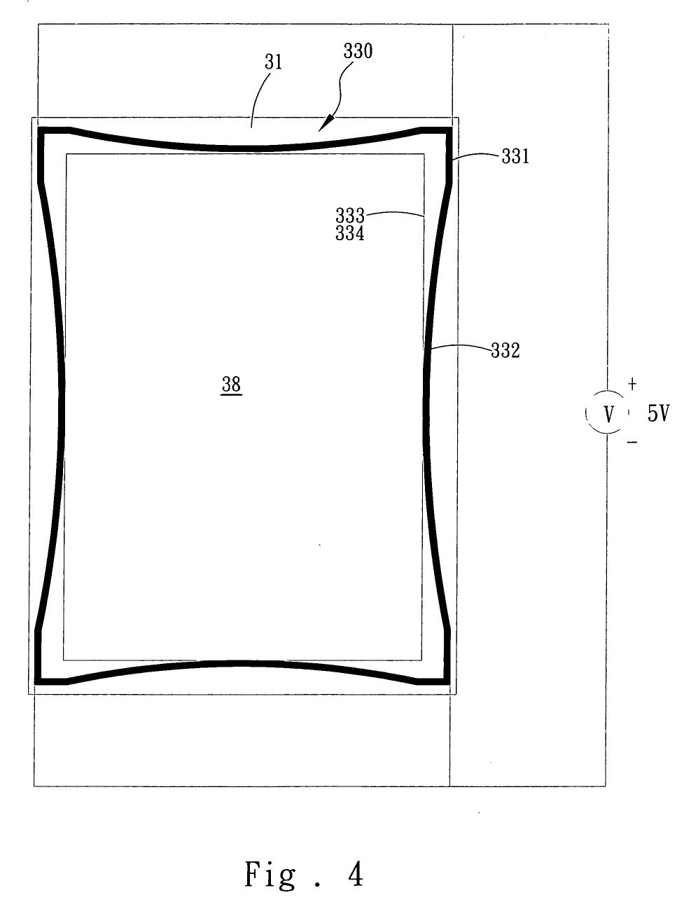

Refer to FIG. 4 for a schematic view of a electrode pattern-voltage line according to the invention. The electrode pattern layer 32 has a electrode pattern 330 formed in a rectangle with a continuous border of four sides. Each side of the border has a straight line 331 on two ends. The middle portion of the electrode pattern 330 is a curve 332 directing inwards towards a touch area 38. Namely, each side of the electrode pattern 330 is continuous consisting of a straight line 331, an inward curve 332 and another straight line 331. Hence when an external constant voltage is applied to the four corners of the electrode pattern 330, the voltage is transferred from the electrode pattern 330 to the lower substrate 31. When the impedance of the electrode pattern 330 and the lower substrate 31 drops and increases with increasing of the distance, and the touch position is on a detection dot line 333, a detected voltage line 334 has a lower impedance at the corners than in the middle portion. Hence the middle portion of the electrode pattern 330 forms a correction to the touch area 38 through the inward curve 332. As a result, the voltages on touch position and the detected position are matched, and the touch panel has an improved linearity.

Therefore, when a voltage is applied to the film electrode pattern 330, the lower substrate 31 of the touch area 38 surrounded by the electrode pattern 330 has a uniform impedance to form a potential difference which is continuous and alters linearly. As a result, the electric signal output from the touch area 38 may be accurately detected by a computer. When users write, draw graphics or select functions on the touch panel, the computer can precisely determine the selected location. And the entire touch area 38, either the middle or the edge portion, can provide a precise touch positioning.

While the preferred embodiments of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An electrode pattern for touch panels comprising from bottom to top in this order a lower substrate, a electrode pattern layer, a dot spacer, a first insulation layer, a conductive wire layer, a second insulation layer, and an upper substrate;
wherein the electrode pattern layer is a continuous pattern formed substantially rectangular with four sides and has two ends of each side formed respectively a straight line and a middle portion of each side formed a curve directing inwards towards a touch area.

2. The electrode pattern for touch panels of claim 1, wherein the electrode pattern layer is formed on a conductive substance of the lower substrate by depositing and etching.
